(19) United States
(12) Patent Application Publication
(10) Pub. No.: US 2010/0018077 A1
(43) Pub. Date: Jan. 28, 2010

(54) SPRING-SUPPORTED ARCH SUPPORT AND METHOD

(76) Inventors: ANDREW MARONE, Las Vegas, NV (US); Jennifer Marone, Las Vegas, NV (US)

Correspondence Address: WEISS & MOY PC, 4204 NORTH BROWN AVENUE, SCOTTSDALE, AZ, 85251, US

(21) Appl. No.: 12/181,123

(22) Filed: Jul. 28, 2008

(51) Int. Cl. A43B 7/22; F16F 3/00

(52) U.S. Cl. 36/91; 267/142

(57) ABSTRACT

An arch support device for an article of footwear includes an upper portion conformed to an underside of a person's foot, a lower portion, and a plurality of springs interposed between the upper portion and the lower portion. The plurality of springs, which may be in front-to-back alignment with each other, are positioned below the plantar calcaneonavicular (spring) ligament. The arch support device is adapted to be positioned within an article of footwear, which may be a shoe or a sandal, for example.

### FIELD OF THE INVENTION

The present invention generally pertains to footwear, and more particularly to a spring-supported arch support for an article of footwear and related method.

### BACKGROUND OF THE INVENTION

Many people suffer from pes planus or have flat feet. Many foot-related symptoms that are treated on a consistent basis are caused by flat feet. Typically, custom orthotics are used to help correct these problems. However, many patients complain that the orthotic insert is too hard, too uncomfortable or that it just doesn't fit into their shoes. Most shoes do not have a sufficient arch with proper flexibility. This means the arch should give with each step then recoil for the next step.

One quarter of all of a person's bones are in the feet and ankles. In order to understand the background of the present invention, it may be helpful to consider the normal human gait. In the following description, the gait cycle will be described from heel strike to toe off.

The first thing to occur in the gait cycle is “heel strike”. The foot hits the ground with the outside (lateral) portion of the heel bone. The ground and friction cause the heel bone to move outward (eversion), allowing the talus bone to slide down and inward, causing the arch to collapse. This is called pronation and is needed for shock absorption. As this occurs, the tibia and rotate interiorly. This causes the pelvis to rotate anteriorly and the lumbar spine (lower back) to move into extension. As weight is passed over the foot it is unlocked (pronated), allowing the foot to be flexible for shock absorption. The plantar calcaneonavicular (spring) ligament helps support the talus bone as it is moving into pronation. As the person prepares for “toe off,” the opposite starts to occur. The tibia and femur laterally rotate, lifting the talus up and outward and creating the arch again. This is called supination (locked foot) and is important for toe off of the big toe and on a rigid foot.

Most people over-pronate during the gait cycle. That means they are dropping their arches too soon, too fast, and too deeply. This causes ligament laxity in the joints of the feet (i.e., an over-stretched ligament). This causes muscle over-use, which can lead to pain and inflammation. The foot is considered the base of the spine when a person is upright. Any problem at the foot can translate all the way up the spine. Many people experience lower back pain due to chronic over-pronation.

### SUMMARY OF THE INVENTION

In accordance with an embodiment of the present invention, an arch support is disclosed. The arch support comprises, in combination: an upper portion having an upper surface and an underside; wherein an upper surface of the upper portion is contoured to conform to a shape of an underside of a wearer's foot, including an arch region thereof; a lower portion; a plurality of springs interposed between the upper portion and the lower portion; and wherein the plurality of springs are positioned to be below the wearer's plantar calcaneonavicular ligament.

In accordance with another embodiment of the present invention, a combination arch support device and footwear device is disclosed. The device comprises, in combination: an arch support comprising: an upper portion having an upper surface and an underside; wherein an upper surface of the upper portion is contoured to conform to a shape of an underside of a wearer's foot, including an arch region thereof; a lower portion; a plurality of springs interposed between the upper portion and the lower portion; and wherein the plurality of springs are positioned to be below the wearer's plantar calcaneonavicular ligament; and a footwear device; wherein the footwear device is adapted to receive the arch support therein.

In accordance with a further embodiment of the present invention, a method for treating conditions associated with one of flat feet and over-pronation is disclosed. The method comprises providing an arch support comprising, in combination: an upper portion having an upper surface and an underside; wherein an upper surface of the upper portion is contoured to conform to a shape of an underside of a wearer's foot, including an arch region thereof; a lower portion; a plurality of springs interposed between the upper portion and the lower portion; and wherein the plurality of springs are positioned to be below the wearer's plantar calcaneonavicular ligament; and a user walking with the arch support located in an article of footwear worn by the user.

### BRIEF DESCRIPTION OF THE DRAWINGS

FIG. 1 is a side, cross-sectional view of a shoe having a spring-supported arch consistent with an embodiment of the present invention.

FIG. 2 is an end, cross-sectional view of the combination spring-supported arch support and shoe of FIG. 1.

FIG. 3 is a front, cross-sectional view of the combination spring-supported arch support and shoe of FIG. 1.

FIG. 4 is a front, perspective, cross-sectional view of the combination spring-supported arch support and shoe of FIG. 1.

FIG. 5 is a rear, perspective, cross-sectional view of the combination spring-supported arch support and shoe of FIG. 1.

FIG. 6 is a side, cross-sectional view of a sandal having a spring-supported arch consistent with an embodiment of the present invention.

FIG. 7 is an end, cross-sectional view of the combination spring-supported arch support and sandal of FIG. 6.

FIG. 8 is a front, perspective, cross-sectional view of the combination spring-supported arch support and sandal of FIG. 6.

FIG. 9 is a rear, perspective, cross-sectional view of the combination spring-supported arch support and sandal of FIG. 6.

### DETAILED DESCRIPTION OF THE INVENTION

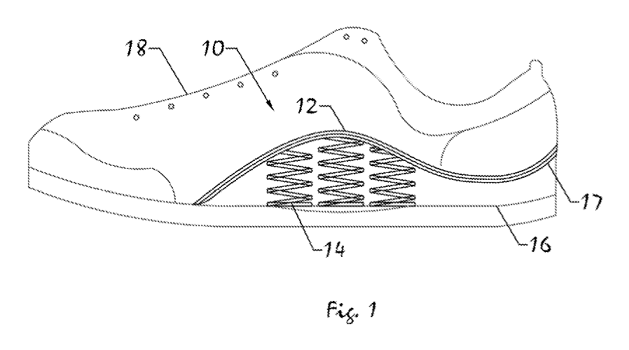

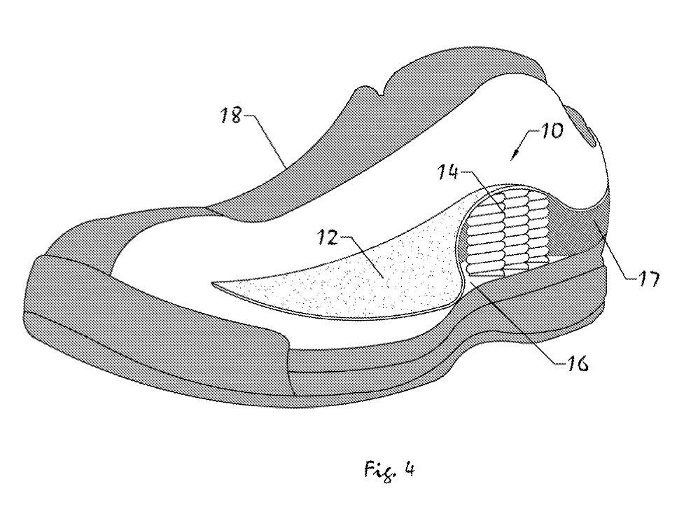

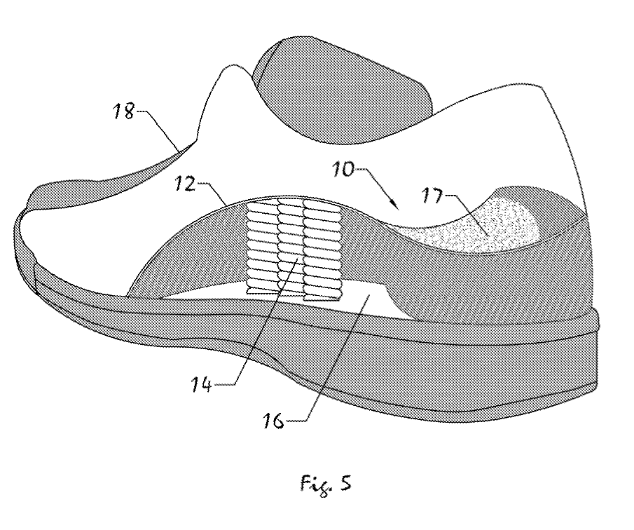

Referring first to FIGS. 1-5, an arch support device 10 (“arch support 10”) consistent with an embodiment of the present invention is illustrated. The arch support 10 generally comprises a contoured upper portion 12, configured to conform to an inferior surface of a person's arch and heel and a plurality of springs 14, located within an area of a person's arch below the plantar calcaneovicular ligament. The arch support 10 may further include a lower portion 16, which may be in addition to or which may comprise a molded inner sole of a shoe 18.

Referring first to the contoured upper portion 12, this is preferably formed from a deformable material capable of retaining a conforming shape like that shown in FIG. 1, while also being sufficiently deformable to provide a comfortable fit to a wearer. For example, a foam type of material such as those used in prior art orthotic devices may be utilized.

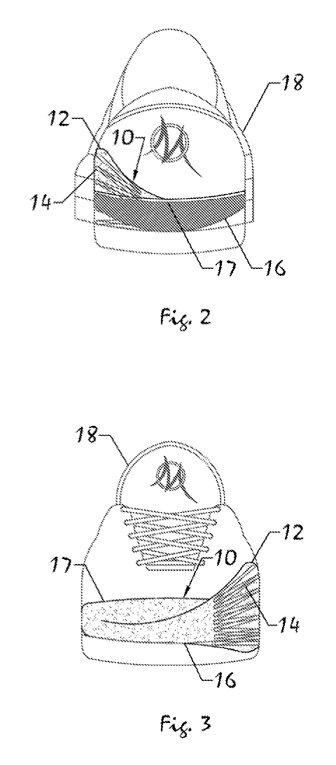

The plurality of springs 14, as noted above, are located within an area of a person's arch. As shown herein, three springs 14 may be provided, though a different number of springs may be provided without departing from the spirit or scope of the present invention. As shown by way of example in FIGS. 2-3, in one embodiment, the springs 14 are in front-to-back alignment with each other. The springs 14 are attached, at an upper portion thereof, to an underside of the upper portion 12. In one embodiment, attachment is accomplishment by imbedding ends of the springs 14 into the underside of the upper portion 12.

The springs 14 have a length sufficient to provide full contact between an outer surface of the upper portion 12 and an underside of an arch portion of the wearer's foot. For adults, an overall height of the arch support 10 may be in the range of from about one to about one and one-half inches. For children, the overall height of the arch support 10 may be in the range of from about one-half to about three-quarters of an inch. The strength of the springs 14 should depend on the size of the person who will be utilizing the arch support 10. It may be noted that a person's step generates downward force of about two to three times body weight, and the tension of the springs 14 should be sufficient to accommodate that. Accordingly, sizing of the arch support 10 should take into account both a wearer's shoe size and a wearer's weight, with the tension of the springs 14 being suitable for a person within a particular weight range. It may be desired, for example, to provide some plurality—for example three or so—of spring tensions for each shoe size or range of sizes, depending on a user's weight. For example, an arch support 10 for a men's shoe size 11 might come in three different tensions—A, B and C—with the strongest tension being intended for the heaviest weight range, the medium tension being intended for the middle weight range, and the lowest tension being intended for the lightest weight range wearer's for that particular shoe size. In one embodiment, it may be desired to provide means (not shown) to increase or decrease tension of the springs 14.

With the arch support 14 properly positioned so that the springs 14 are applying upward tension proximate the apex or the highest part of the medial side of the arch, the arch support 14 acts similarly to the plantar calcaneonavicular (spring) ligament. The springs 14 give, allowing for normal pronation, and then rebound for supination and the next step in gait. It should be noted that the location of the springs 14 is in the arch because that is where the true spring action of the foot should occur, as opposed to in the heel or forefoot.

Referring now to the lower portion 16 of the arch support 10, it may be comprised of a firm or a soft material. A heel area 17 of the upper portion 12 preferably has a cup shape, to allow for the height of the arch support 14 and for the comfort of the wearer. The arch support 14 may be inserted into an existing shoe 18 or, alternatively, may be integrated into a shoe 18 during the manufacturing process, with the lower portion 16 also serving as a sole of the shoe 18. The use of a shoe 18 is to create foot wear that gives enough support but allows flexibility for normal foot function.

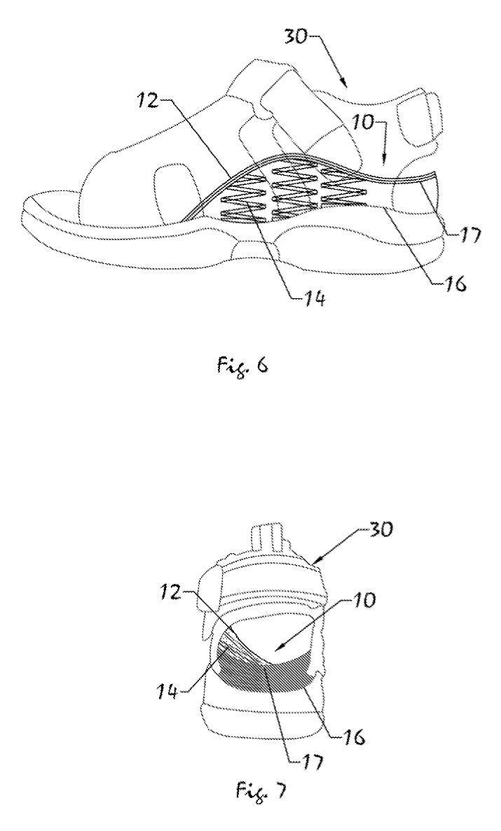

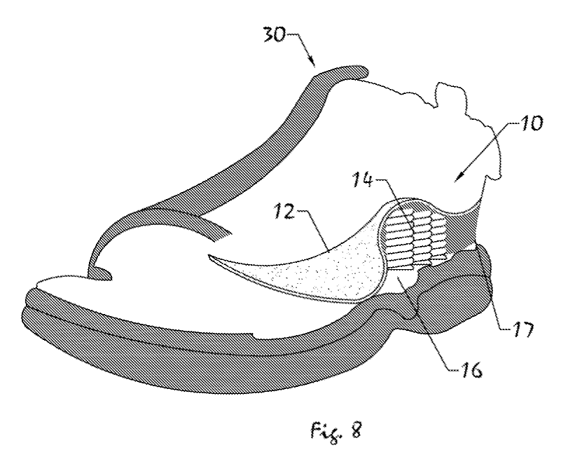

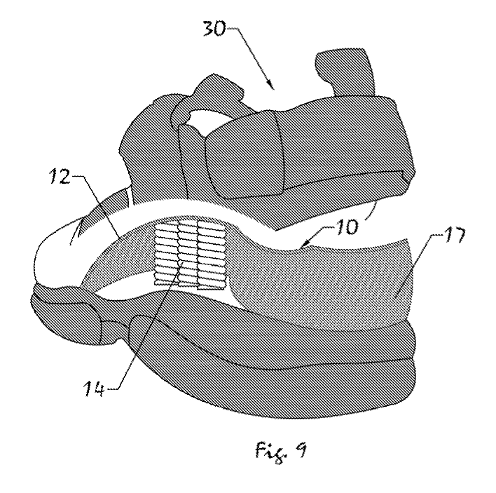

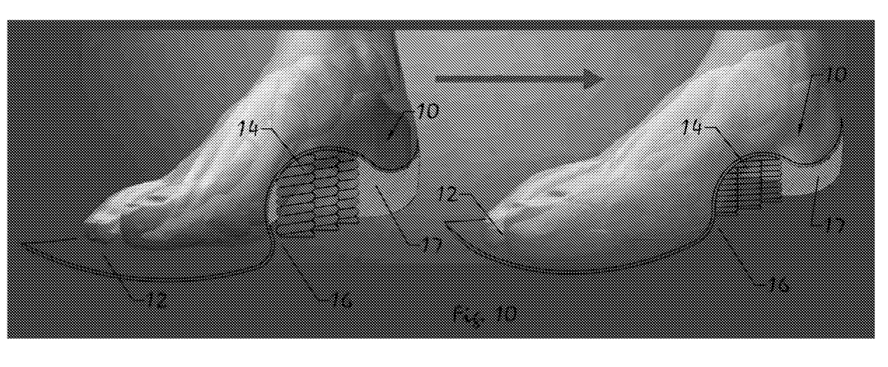

Attention is directed to FIGS. 6-9, which show an embodiment of the present invention wherein an arch support 10 having a contoured upper portion 12, a lower portion 16, and a plurality of springs 14 interposed therebetween is positioned with a sandal 30. A back strap may be employed with certain sandals to help keep the shoe on, especially for small children. As illustrated herein, it should be noted that the principles of the present invention may be applied to virtually any type of footwear, including but not limited to casual shoes, molded wide band sandals, athletic shoes, work boots, boots, leather shoes with permanent insoles, closed clog-type shoes, etc.

The arch support 10 of the present invention decreases the chances of developing common dysfunctions such as, plantar fasciitis, foot/ankle pain, knee pain, hip pain, and lower back pain.

Although particular embodiments of the invention have been described in detail for purposes of illustration, various modifications may be made without departing from the spirit and scope of the invention. Accordingly, the invention is not to be limited, except as by the appended claims.

We claim:

1. An arch support comprising, in combination:
an upper portion having an upper surface and an underside;
wherein an upper surface of the upper portion is contoured to conform to a shape of an underside of a wearer's foot, including an arch region thereof;
a lower portion;
a plurality of springs interposed between the upper portion and the lower portion; and
wherein the plurality of springs are positioned to be below the wearer's plantar calcaneonavicular ligament.

2. The arch support of claim 1 wherein the upper portion is comprised of a deformable material capable of retaining a conforming shape.

3. The arch support of claim 1 wherein the arch support includes three springs interposed between the upper portion and the lower portion.

4. The arch support of claim 1 wherein the springs are aligned with one another.

5. The arch support of claim 1 wherein the arch support has a height in a range of from about one to about one and one-half inches.

6. The arch support of claim 1 wherein the arch support has a height in a range of from about one-half to about three-quarters of an inch.

7. A combination arch support device and footwear device comprising, in combination:
an arch support comprising:
an upper portion having an upper surface and an underside;
wherein an upper surface of the upper portion is contoured to conform to a shape of an underside of a wearer's foot, including an arch region thereof;
a lower portion;
a plurality of springs interposed between the upper portion and the lower portion; and
wherein the plurality of springs are positioned to be below the wearer's plantar calcaneonavicular ligament; and
a footwear device;
wherein the footwear device is adapted to receive the arch support therein.

8. The combination arch support device and footwear device of claim 7 wherein the lower portion of the arch support is a sole of the footwear device.

9. The combination arch support device and footwear device of claim 7 wherein the footwear device is a shoe.

10. The combination arch support device and footwear device of claim 6 wherein the footwear device is a sandal.

11. A method for treating conditions associated with one of flat feet and over-pronation, comprising:
providing an arch support comprising, in combination:
an upper portion having an upper surface and an underside;
wherein an upper surface of the upper portion is contoured to conform to a shape of an underside of a wearer's foot, including an arch region thereof;
a lower portion;
a plurality of springs interposed between the upper portion and the lower portion; and
wherein the plurality of springs are positioned to be below the wearer's plantar calcaneonavicular ligament; and
a user walking with the arch support located in an article of footwear worn by the user.

12. The method of claim 11, further comprising inserting the arch support into the article of footwear.

13. The method of claim 11 wherein the arch support includes three springs interposed between the upper portion and the lower portion.

14. The method of claim 11 wherein the springs are aligned with one another.

15. The method of claim 11 wherein the footwear device is a shoe.

16. The method of claim 11 wherein the footwear device is a sandal.

17. The method of claim 11 wherein the step of providing an arch support further comprises providing a user with a choice between at least a first and a second arch support, wherein the plurality of springs in the first arch support has a first strength and wherein the plurality of springs in the second arch support has a second, different strength.
